(19) United States
(12) Patent Application Publication
(10) Pub. No.: US 2015/0014349 A1
(43) Pub. Date: Jan. 15, 2015

(54) Dispensing Contents from Selected Chambers

(71) Applicant: Michael Rau, Mapleton, UT (US)

(72) Inventor: Michael Rau, Mapleton, UT (US)

(21) Appl. No.: 13/939,496

(22) Filed: Jul. 11, 2013

(51) Int. Cl. A47G 19/34; G01F 11/00; G01F 15/00

(52) U.S. Cl. CPC A47G 19/34; G01F 15/001; G01F 11/003
USPC 222/1; 222/144

(57) ABSTRACT

Dispensing contents from selected chambers includes measuring a selected volume of contents within a container by rotating a dial located on an underside of multiple chambers in a rotatable drum of the container to open a selected number of the multiple chambers where the selected number of the multiple chambers cumulatively forms the selected volume.

### BACKGROUND

Spice containers typically include a removable lid to provide access to the spice housed within the container. In some cases, when the lid is removed, a user can pour the desired amount of spice out of an opening in the container into a measuring spoon to measure the amount of spice that the user desires to dispense from the spice container. In other cases, a cap connected to the opening of the container is under the container's lid. The cap includes perforations or other types of holes in the cap that restrict the flow of spice as the spice is poured out of the container. In such an example, the restriction prevents too much spice from exiting the container at once to prevent wasting the spice.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1 is an orthogonal diagram of an example of a container according to the principles described herein.

FIG. 2A is an orthogonal diagram of an example of an underside of a container according to the principles described herein.

FIG. 2B is an orthogonal diagram of an example of an underside of a container according to the principles described herein.

FIG. 3 is an exploded diagram of an example of a container according to the principles described herein.

FIG. 4 is a cross sectional diagram of an example of a container according to the principles described herein.

FIG. 5 is a diagram of an example of a method for dispensing contents from selected chambers according to the principles described herein.

FIG. 6 is a diagram of an example of a method for dispensing contents from selected chambers according to the principles described herein.

FIG. 7 is a cross sectional diagram of an example of a dispensing assembly according to the principles described herein.

### DETAILED DESCRIPTION

To measure a desired amount of spice from a spice container, the user often uses a measuring spoon or another type of measuring mechanism. Thus, the user has to use a second device to get the desired spice measurement. Generally, the user relies on visual clues based on the size of the measuring spoon and the amount of spice that appears to be in the measuring spoon. However, such visual estimates are generally not precise. To measure an exact amount of spice, the user pours the spice into the measuring spoon until the spice in the measuring spoon appears to be close to the desire amount. Then, the user may shake the measuring spoon to level the spice in the measuring spoon to get a better understanding of how much spice is in the measuring spoon. If there is not enough spice, the user proceeds to repeat the process of pouring and shaking until the desired amount of spice is measured. If too much spice is poured into the measuring spoon, the excess spice can be returned to the container. Such a process can involve multiple steps.

The principles described herein include a container that allows a user to dispense an accurate amount of desired contents in a container in a relatively quick process. Such a container includes a body forming a cavity that is rotatably connected to a rotatable drum that contains multiple chambers with fixed volumes. The fixed volumes of the rotatable drum are in communication with the cavity when the rotatable drum is rotated to a first position. The fixed volumes of the rotatable drum are separated from the cavity when the rotatable drum is rotated to a second position. The container further includes a discharging mechanism that selectively opens at least one of the multiple chambers.

The principles described herein also include a method for dispensing contents from multiple chambers. Such a method includes measuring a selected volume of contents within a container by rotating a dial located on an underside of multiple chambers in a rotatable drum of the container to open a selected number of the multiple chambers where the selected number of the multiple chambers cumulatively forms the selected volume. The method can further include releasing the selected volume by rotating the rotatable drum to a release position.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

FIG. 1 is an orthogonal diagram of an example of a container (100) according to the principles described herein. In this example, the container (100) includes a body (102) that forms an internal cavity. The internal cavity is enclosed by a lid (104) attached to a first end (106) of the container (100). Further, the internal cavity is in communication with internal chambers of a rotatable drum (108) located on a far side (110) of the body (102) from the lid (104) when the rotatable drum is in a first azimuthal position. When the internal chambers are in communication with the body's internal cavity, the contents of the body's internal cavity can flow from the internal cavity into the rotatable drum's internal chambers. For example, if the body's internal cavity includes a spice when the rotatable drum is rotated to the first azimuthal position, the spice will fill the rotatable drum's internal cavities.

When the rotatable drum (108) is rotated to a second azimuthal position, the internal chambers rotate with the rotatable drum to a position where the internal chambers are no longer in communication with the body's internal cavity. Thus, at the second position, the contents of the body's internal cavity do not flow into the internal chambers of the rotatable drum.

A dial (112) is located on a second end (114) of the container (100) and adjacent to the rotatable drum. The dial (112) includes an opening that can align with a selected number of the internal cavities. For example, if there are three internal cavities, the dial can be used to select which of the internal cavities will discharge its contents. When the dial's opening is aligned with the first of the internal cavities, the contents of the first internal cavity will be discharged out the second end (114) of the container (100). The user can select the number of the rotatable drum's internal chambers to with the dial. For example, if the user uses the dial to select two of the internal chambers, the contents from both the first and the second internal chambers will be released out the second end (114) of the container. Likewise, if the user selects three of the internal chambers with the dial, the contents of the three internal chambers will be released from the second end (114) of the container (100).

The internal chambers cumulatively form the discrete volumes that can be released as a single volumetric unit from the second end (114) of the container (100). For example, the first of the internal chambers may have a discrete volume of ¼ teaspoon. Thus, if the user wants to dispense a ¼ teaspoon of the contents in the container, the user can align the dial's opening to include just the first of the internal chambers, which will release just a ¼ teaspoon of the container's contents. The second internal chamber may also include a discrete volume of ¼ teaspoon. In such an example, if the user desires to release a ½ teaspoon, the user can rotate the dial such that the dial's opening aligns with both the first and the second internal chambers. As a result, the contents of both the first and the second internal chambers are released from the second end (114) of the container (100), which amounts to ½ teaspoon (¼ teaspoon from the first internal chamber and another ¼ teaspoon from the second internal chamber).

A third internal chamber may include a discrete volume of a ½ teaspoon. Thus, if the user desires to dispense an entire teaspoon from the container (100), the user can select a full teaspoon with the dial. As a result, the contents of each of the three internal chambers will be release (totaling an entire teaspoon) is released from the second end (114) of the container (100). While this example has been described with reference to a specific number of internal chambers, any number of internal chambers may be used in accordance with the principles described herein. Further, while this example has been described with reference to specific discrete and cumulative volumes of the internal chambers, any discrete or cumulative volume may be used in accordance with the principles described herein.

The rotatable drum's internal chambers may be located side by side, and the dial (112) may include a preset mechanism that allows a user to determine when the dial's opening is aligned with the desired number of internal chambers. For example, the preset mechanism may include a protrusion formed on the bottom plate that is configured to interlock into recesses formed in the dial at discrete alignments. For example, the notch may snap into a first recess at a first location when the dial's opening aligns with a first internal cavity. Further, the notch may snap into a second recess at a second location when the dial's opening aligns with the first and second internal cavities. Also, the notch may snap into a third recess at a third location when the dial's opening aligns with the first, second, and third internal cavities.

The internal cavities may be labeled based on their cumulative volumes. For example, the first internal cavity may include a label located on the container (100) that is visible to the user. Such a label may include a window (116) formed in the rotatable drum (108). In other examples, the labels are located elsewhere on the container (100). The label that corresponds to the first internal chamber may include an indication of the volume of just the first internal chamber, such as a ¼ teaspoon. The label for the second internal chamber may include an indication of the cumulative volumes for the first and the second internal chambers, such as a ½ teaspoon where the first and second internal chambers each have ¼ teaspoon. The label for the third internal chamber may include an indication of the cumulative volumes for the first, second, and third internal chambers, such as a full teaspoon where the first chamber has a ¼ teaspoon, the second chamber has a ¼ teaspoon, and the third internal chamber has a ½ teaspoon.

The container may be used to dispense any appropriate contents from the container. For example, the container may be used to dispense spices, such as dried seeds, fruits, roots, barks, vegetative substances, cooking spices, other types of spice, or combinations thereof. In other examples, other types of contents may be used, such as pigments, dyes, herbs, candy, sugar, salt, pepper, medicine, vitamins, tablets, pills, other contents, or combinations thereof. Further, the contents may be in any appropriate physical form. For example, the contents may have a solid form, a liquid form, a semi-liquid form, or combinations thereof. The contents may take the form of balls, cubes, sticks, powder, symmetric shapes, asymmetric shapes, other forms, or combinations thereof.

In some examples, the lid (104) retains the ability to be opened to refill the internal cavity of the body with contents. Further, the lid (104) may also be used for traditional uses, such as pouring the contents out of the first end (106) of the container verses through the dispensing mechanism that measures precise amounts of the contents.

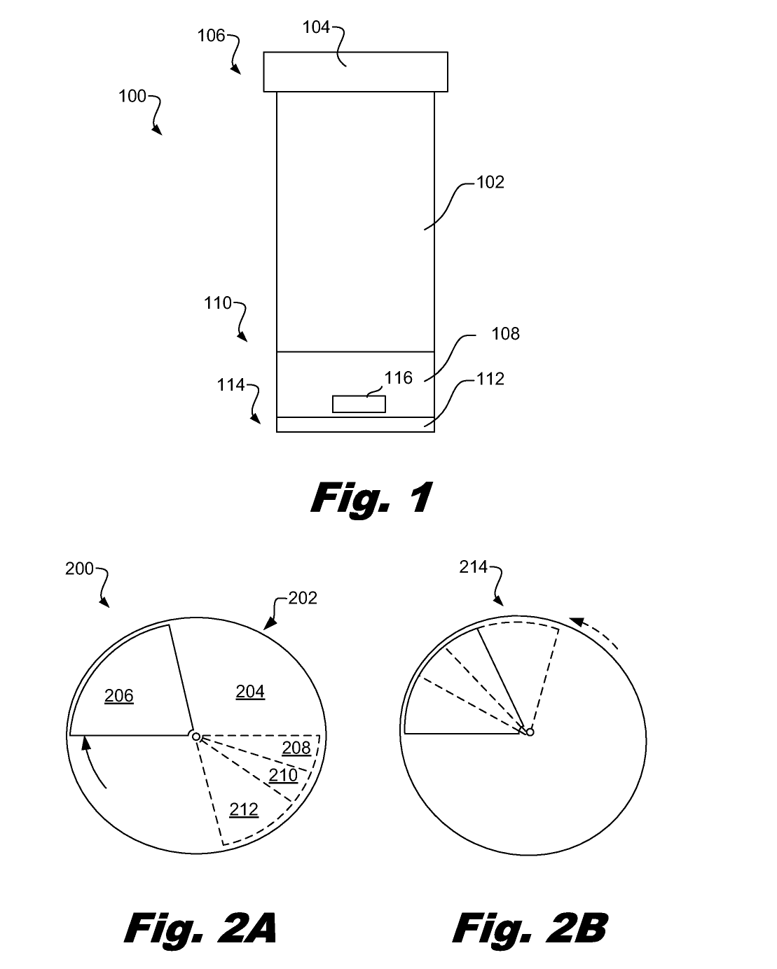

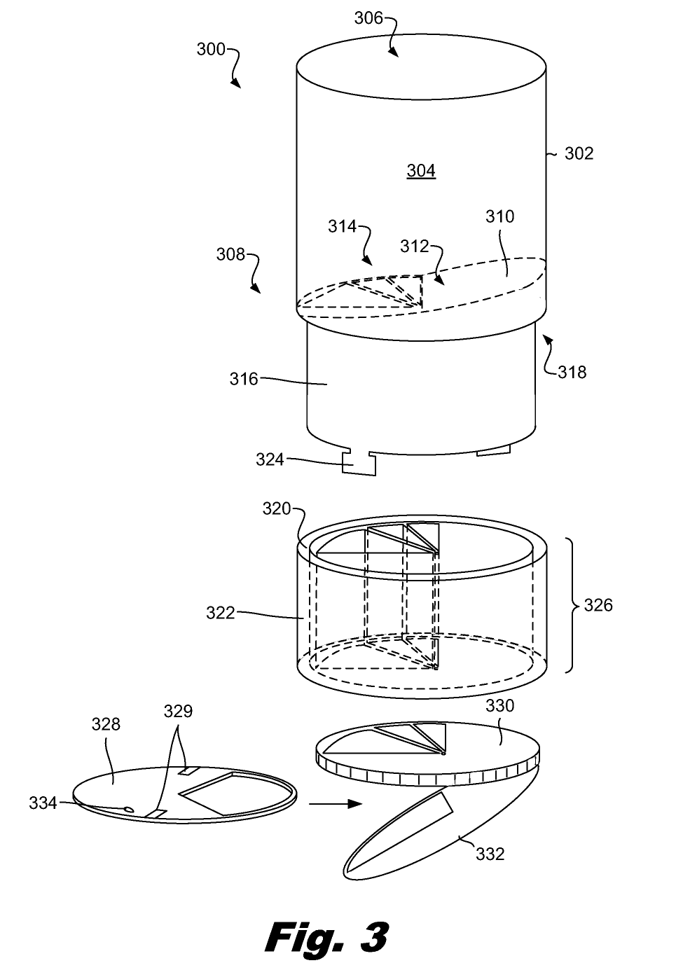

FIG. 2A is an orthogonal diagram of an example of an underside (200) of a container (202) according to the principles described herein. In this example, the underside (200) includes a dial (204) with an opening (206). The dial (204) is positioned in front of a rotatable drum that has three separate, adjacent internal chambers, which include a first chamber (208), a second chamber (210), and a third chamber (212).

The dial (204) may be preset to a discrete location and/or orientation that corresponds with a desired volume to release from the container (202). In this example, the user first presets the dial (204) to the discrete location. As the user presets the dial (204), the opening (206) moves to a corresponding location. In the example of FIG. 2, the corresponding location of the preset does not overlap yet with the selected number of internal chambers in the rotatable drum.

After the dial (204) is preset to the corresponding location, the rotatable drum is rotated, which causes the internal chambers (208, 210, 212) to move such that at least one of the internal chambers (208, 210, 212) aligns with the dial's opening (206) as depicted in FIG. 2B. In the example of FIG. 2B, the first internal chamber (208) and the second internal chamber (210) are aligned with the dial's opening (206). As a result, the contents in the first and second internal chambers (208, 210) release their contents from the container (202). Thus, the example depicted in the example of FIG. 2A corresponds to selecting a cumulative volume formed by both the first and second internal chambers (208, 210).

The process of first presetting the dial (204) and then rotating the rotatable drum to align the selected number of internal chambers with the dial's opening (206) can prevent the contents from the container's body cavity from flowing immediately from the body's cavity out of the dial's opening. As the dial (204) is preset, the rotatable drum is in a first position where the internal chambers (208, 210, 212) are in communication with the internal cavity of the container's body. After the preset is selected, the rotatable body is rotated to a selected position (214) such that the internal chambers (208, 210, 212) of the rotatable drum are no longer in communication with the body's cavity. As a result, when the selected chambers are aligned with the dial's opening (206) and the contents therein are released, the selected chambers will not refill because the contents of the body's cavity cannot flow from the body's cavity to the drum's internal chambers (208, 210, 212). However, when the rotatable drum is rotated back from the selected position to the first position, the internal chambers (208, 210, 212) are brought back into communication with the body's cavity such that the contents of the body's cavity can refill the emptied internal chambers.

In some examples, the rotatable drum is automatically returned from the selected position to the first position with a return mechanism. The return mechanism may include any appropriate mechanism to automatically return the rotatable drum to the first position. For example, such a mechanism may include a spring that pushes or pulls the rotatable drum back to the first position. The spring may be a tension spring, a compression spring, a wave spring, another type of spring, or combinations thereof. In other examples, the return mechanism includes other types of return mechanisms such an elastomeric material, a wedged shaped urging member, a slope, a bearing, a hinge, another type of return mechanism, or combinations thereof.

While the example of FIG. 2 has been described with reference to presetting the dial before rotating the rotatable drum to the selected position, in other examples, the rotatable drum can be rotated to the selected position before the dial is set. In other examples, the container allows the user to preset the dial or rotate the rotatable drum in any order.

FIG. 3 is an exploded diagram of an example of a container (300) according to the principles described herein. In this example, the container (300) has a body (302) that forms an internal cavity (304). The first end (306) of the body (302) is shaped to receive a lid and/or cap and can be used for filling and refilling the internal cavity (304) of the body (302). The second end (308) of the container's body (302) has a sloped section (310). The sloped section (310) directs the body's contents towards floor openings (312) in the internal cavity's floor (314). The contents that are directed towards the floor openings (312) fall from the internal cavity (304) into the internal chambers of the rotatable drum (322). When the rotatable drum (322) is in the refill position, each of the internal chambers is in communication with the internal cavity such that the contents of the internal cavity can flow into the internal chambers of the rotatable drum (322). In some examples, the internal cavity's floor (314) includes a single opening in communication with each of the internal chambers. In other examples, each of the internal chambers has a corresponding opening in the internal cavity's floor.

An annular protrusion (316) is formed on the underside (318) of the internal cavity's floor (314). The annular protrusion (316) is formed to fit within an annular track (320) formed in the rotatable drum (322). In some examples, the rotatable drum has a transparent section that allows the user to determine whether the internal chambers of the rotatable drum (322) are full with contents from the internal cavity of the container's body. In the example of

FIG. 3, the rotatable drum (322) is made of a transparent material that allows the user to see how full the internal chambers are.

Also in the example of FIG. 3, the annular protrusion (316) includes tabs (324) that extend beyond the length (326) of the rotatable drum (322). These tabs (324) interlock with plate (328) at features (329) formed in the plate (328). Thus, the body (302) of the container (300) and plate (328) are rotatably fixed to one another. The tabs (324) pass through slots in the bottom of the track (320), thus, the interactions between the slots and the tabs also limit the rotation of the rotatable drum. The slots can be sized such that when the tabs abut against the end of the slots that the rotatable drum is positioned in the correct orientation. While this example has been described with reference to a specific mechanism for rotationally fixing the plate (328) with the body (302), any appropriate mechanism for rotationally fixing the plate (328) and the body (302) together may be used in accordance with the principles described herein. For example, the plate (328) may be integrally formed with the body (302) through an additive manufacturing process, like three-dimensional printing, laser lithography, another type of additive manufacturing process technique, or combinations thereof. In other examples, the plate (328) and the body (302) may be rigidly fixed to one another with screws, nails, glue, tape, another type of fastener, or combinations thereof.

The dial (330) is positioned between the rotatable drum (322) and plate (328). The dial (330) is rotationally independent of the body (302) and the rotatable drum (302). The rotatable drum (302) is also rotationally independent of the dial (330) and the body (302). In some examples, the rotatable drum (322), the dial (330), the body (302), and the plate (328) share a common central and/or rotary axis. In some examples, the rotatable drum (322), the dial (330), the body (302), and the plate (328) are also connected by a central shaft that aligns these parts together and adds additional stability.

The dial (330) includes a trap (332) that is intended to keep the contents within the container (300) until the contents are intended to be released. For example, the user may preset the dial (330) and rotate the rotatable drum (322) to the release position while the trap (332) is closed. In such an example, the contents will not be dispensed from the container (300) until the user opens the trap (332). In other examples, the user may open the trap (332) before the user rotates the rotatable drum (322) to the release position such that the contents are released immediately after the rotatable drum (322) is at the release position.

A notch (334) is formed in the plate (328). The notch (334) may be used to snap into a recess formed in the dial (330). In other examples, a notch may be formed on the dial (330). In such an example, the notch (330) may snap into a recess formed in another part of the container (300) such as the plate (328). While this example has been described with specific reference to presetting the dial with a notch and recess combination, any appropriate mechanism for presetting the dial may be used in accordance with the principles described herein.

While this example has been described with reference to specific ways to construct the container, any appropriate way to construct the container may be used in accordance with the principles described herein. For example, in some instances, the dial may not include a trap. Further, a central shaft may be used to connect the dial, the rotatable drum, and the body. In some examples, another mechanism besides an annular protrusion and annular track are used to connect the body with the rotatable drum such that the body and the rotatable drum are rotationally independent of one another. Further, the sloped section of the internal chamber floor may have any appropriate slope and/or geometry to direct the contents of the body towards the floor openings. In some examples, the body floor does not have a slope or shape that is used to direct the contents towards the floor openings.

While the examples above have been described with reference to the internal chambers of the rotatable drum having pie wedge shapes, the internal chambers may have any appropriate shape that allows the internal chambers to cumulatively form discrete volume amounts. Further, while the example of FIG. 3 depicts the internal chambers occupying about a fourth of the volume occupied by the rotatable drum, the internal chambers may occupy any appropriate amount of space. For example, the rotatable drum may have a shorter length than depicted in the example of FIG. 3 with wider internal chambers.

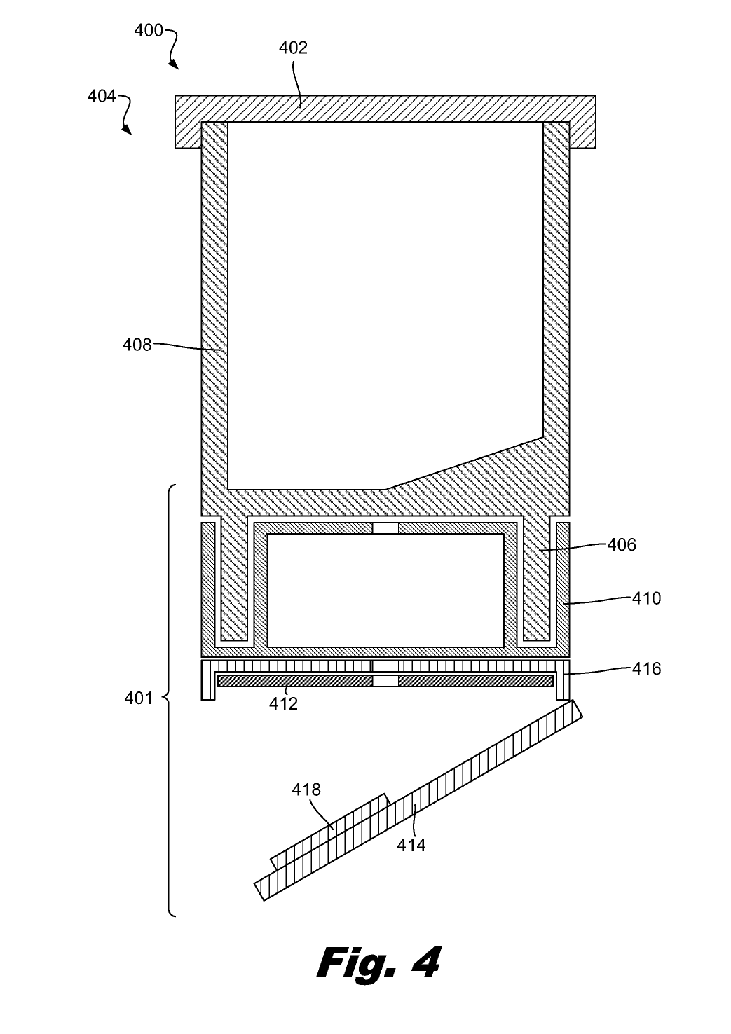

FIG. 4 is a cross sectional diagram of an example of a container (400) according to the principles described herein. In this example, the container (400) has a lid (402) that is positioned over a first end (404) of the container (400). The container (400) has an integral connection to a dispensing assembly (401). The dispensing assembly (401) includes the annular protrusion (406), which is integrally formed with the body (408) of the container (400). Further, the rotatable drum (410) is positioned underneath the body (408). The plate (412) is positioned between the trap (414) and the dial (416). The trap (414) has a raised section (418) that has a greater cross sectional thickness than the rest of the trap (414). The raised section (418) is used to plug the opening formed in the plate (412) that allows the contents to empty out of the internal chambers of the rotatable drum (410).

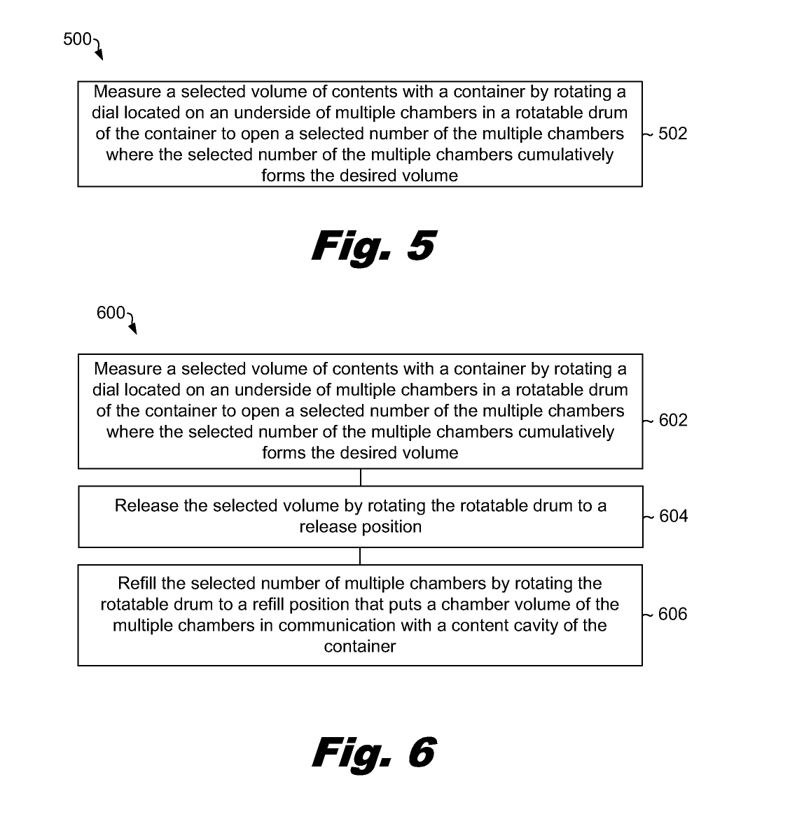

FIG. 5 is a diagram of an example of a method (500) for dispensing contents from selected chambers according to the principles described herein. In this example, the method (500) includes measuring (502) a desired volume of contents with a container by rotating a dial located on an underside of multiple chambers in a rotatable drum to open a selected number of the multiple chambers where the selected number of multiple chambers cumulatively forms the desired volume.

Such a method may be performed with any appropriate dispensing assembly and/or container. For example, the method may be performed with a container where the dispensing assembly is integrally formed with the container. In other examples, the method may be performed with a dispensing assembly that is capable of independently attaching to existing containers.

FIG. 6 is a diagram of an example of a method for dispensing contents from selected chambers according to the principles described herein. In this example, the method (600) includes measuring (602) a desired volume of contents with a container by rotating a dial located on an underside of multiple chambers in a rotatable drum of the container to open a selected number of the multiple chambers where the selected number of multiple chambers cumulatively forms the desired volume, releasing (604) the selected volume by rotating the rotatable drum to a release position, and refilling (606) the selected number of the multiple chambers by rotating the rotatable drum to a refill position that puts a chamber volume of the multiple chambers in communication with a content cavity of the container.

The multiple chambers of the container can cumulatively form multiple dispensing volumes. For example, the first internal chamber may be ¼ teaspoon, the second internal chamber may be ¼ teaspoon, and the third internal chamber may be ½ teaspoon. In such an example, the multiple dispensing volumes includes ¼ teaspoon (just the first chamber), ½ teaspoon (the combination of first and the second chambers), and one full teaspoon (the combination of all of the chambers). Such dispensing volumes can be selected by the user when the user presets the dial.

The container may include labels to assist the user in determining how many internal chambers to select. A first label may correspond to the volume of just the first chamber. A second label may correspond to the collective volume of the first and second chamber. A third label may correspond to the collective volume of the first, second, and third chamber. In examples where the rotatable drum includes additional chambers, additional labels may be used to cumulatively identify the first three chambers with other chambers.

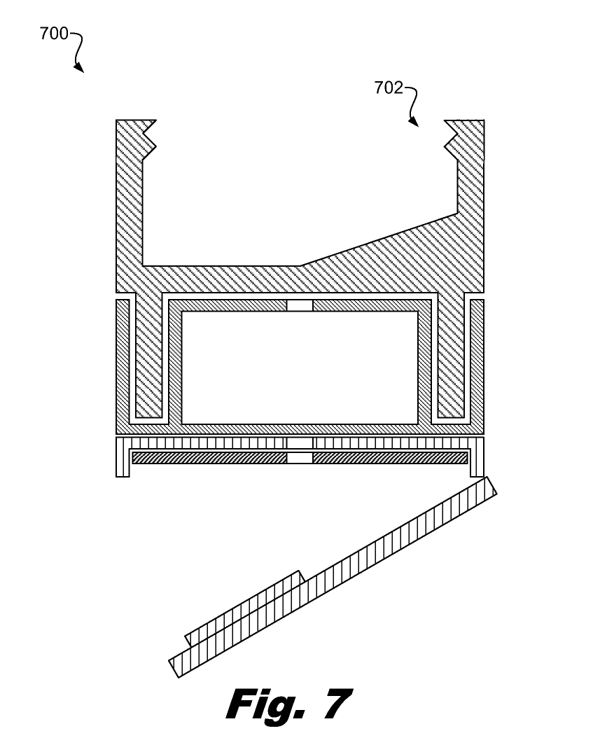

FIG. 7 is a cross sectional diagram of an example of a dispensing assembly (700) according to the principles described herein. In this example, the dispensing assembly (700) includes a threaded connection (702) to a jar or another type of container. The threaded connection (702) may have a thread form that allows the dispensing assembly (700) to thread to where a lid threads to the container. In such an example, a user may unthread a lid of an existing container and replace the lid with the dispensing assembly (700).

While this example has been described with reference to a specific connection that includes a thread form, any appropriate connection of a dispensing assembly to a container may be used in accordance with the principles described herein. For examples, the connection may an integral connection where the container and the dispensing assembly are formed together. In other examples, the connection includes a thread form. In yet other examples, the connection includes a compression fit, an elastomeric material, another type of connection, or combinations thereof.

Any appropriate type of material may be used to construct any part of the container. For example, the container may be made of glass, plastic, wood, metal, another type of material, or combinations thereof. In some examples, the dial and the rotatable drum may be equipped with a bearing. For example, these parts of the container may include smooth surfaces that aid in the rotation of the rotatable drum and/or dial. Such surfaces may be made of similar or dissimilar materials that form the other parts of the container. In some examples, bearing surfaces are made a ceramic or another material that can withstand erosion. Further, the container may include seals that prevent spice, liquid, or other contents from leaking into the bearing surfaces or gaps between the container's moving parts. In some examples, the seal is an O-ring of a suitable diameter and thickness.

While the examples above have been described with specific reference to selecting the desired volume to release from the container with a dial, any appropriate mechanism for selecting the desired volume may be used in accordance with the principles described herein. For example, selecting the volume may include the use of levers, buttons, other mechanisms, or combinations thereof.

While the above examples have been described with reference to the rotatable drum, dial, and other parts of the dispensing assembly being connected to a bottom side of the container, the rotatable drum, dial, and other parts of the dispensing assembly may be connected to the container at any appropriate location. For example, the dispensing assembly may be connected to the top of the container, to the side of the container, to the bottom of the container, to another location on the container, or combinations thereof.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A container for dispensing contents from selected chambers, comprising:
a body forming a cavity;
the body being rotatably connected to a rotatable drum that contains multiple chambers with fixed volumes;
the fixed volumes of the rotatable drum being in communication with the cavity when the rotatable drum is rotated to a first position;
the fixed volumes of the rotatable drum being separated from the cavity when the rotatable drum is rotated to a second position; and
a discharging mechanism that selectively opens at least one of the multiple chambers.

2. The container of claim 1, wherein the discharging mechanism comprises a rotatable plate with an opening where the opening resides under a selected number of the multiple chambers at a selected position.

3. The container of claim 2, wherein the selected number of the multiple chambers is two.

4. The container of claim 2, wherein the selected number of the multiple chambers is three.

5. The container of claim 1, wherein the multiple chambers cumulatively form multiple dispensing volumes, wherein a dispensing volume of the multiple dispensing volumes is operable as a single volume.

6. The container of claim 1, further comprising a return mechanism that moves the rotatable drum from the second position to the first position.

7. The container of claim 6, wherein the return mechanism comprises a spring to automatically rotate the rotatable drum from the second position to the first position.

8. The container of claim 1, wherein the body comprises an extension that protrudes into an annular track of the rotatable drum to control the orientation of the rotatable drum.

9. The container of claim 1, wherein the container comprises a transparent section adjacent the multiple chambers.

10. The container of claim 1, further comprising a plate positioned underside the discharging mechanism that is rotationally fixed with the body.

11. The container of claim 1, wherein a first chamber of the multiple chambers is labeled based on the size of the first chamber and a second chamber of the multiple chambers is labeled based on a cumulative size of the first chamber and the second chamber.

12. A method for dispensing contents from selected chambers, comprising:
measuring a selected volume of contents within a container by rotating a dial located on an underside of multiple chambers in a rotatable drum of the container to open a selected number of the multiple chambers where the selected number of the multiple chambers cumulatively forms the selected volume.

13. The method of claim 12, future comprising releasing the selected volume by rotating the rotatable drum to a release position.

14. The method of claim 12, further comprising refilling the selected number of multiple chambers by rotating the rotatable drum to a refill position that puts a chamber volume of the multiple chambers in communication with content cavity of the container.

15. A dispensing assembly for dispensing contents from selected chambers, comprising:
an connection to a body that forms a cavity;
the connection being rotatably connected to a rotatable drum that contains multiple chambers with fixed volumes;
the fixed volumes of the rotatable drum being in communication with the cavity when the rotatable drum is rotated to a first position;
the fixed volumes of the rotatable drum being separated from the cavity when the rotatable drum is rotated to a second position; and
a discharging mechanism that selectively opens at least one of the multiple chambers.

16. The assembly of claim 15, wherein the attachment is a threaded attachment.

17. The assembly of claim 15, wherein the discharging mechanism comprises a rotatable plate with an opening where the opening resides under a selected number of the multiple chambers at a selected position.

18. The assembly of claim 15, wherein a first chamber of the multiple chambers is labeled based on the size of the first chamber and a second chamber of the multiple chambers is based on a cumulative size of the first chamber and the second chamber.

19. The assembly of claim 15, wherein the multiple chambers cumulatively form at least two dispensing volumes, wherein a cumulative volume is opened from the container as a single unit.

20. The assembly of claim 15, further comprising a spring that automatically moves the rotatable drum from the second position to the first position.
